(19) United States
(12) Patent Application Publication
(10) Pub. No.: US 2005/0220330 A1
(43) Pub. Date: Oct. 6, 2005

(54) Method of inspecting an mura defect in a pattern and apparatus used for the same

(75) Inventors: Masaaki Kobayashi, Tokyo (JP); Atsushi Hara, Tokyo (JP); Noboru Yamaguchi, Kumamoto (JP); Yuudai Ishikawa, Kumamoto (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 11/094,357

(22) Filed: Mar. 31, 2005

(30) Foreign Application Priority Data
Mar. 31, 2004 (JP) P.2004-106462

(51) Int. Cl. G06K 9/00

(52) U.S. Cl. 382/141

(57) ABSTRACT

A mura defect inspection apparatus 10 having an illuminating unit 12 which irradiates light onto a photomask 50 having a chip 55 on the surface thereof, the chip is formed with a repeated pattern that a unit pattern is regularly arranged, and a photoreceptor 13 which receives scattered light generated at the edge part of the unit pattern of the repeated pattern on the chip of the photomask and converts it to received light data, wherein the received light data is analyzed to detect a mura defect generated in the repeated pattern, wherein the illuminating unit irradiates light that is emitted from an illumination light source and has a orientation property of the rays almost parallel, the light having a parallelism within an angle of 2°, for example, onto a repeated pattern 51 on the chip 55 of the photomask 50.

This application claims foreign priority based on Japanese Patent application No. 2004-106462, filed Mar. 31, 2004, the contents of which is incorporated herein by reference in its entirety.

### BACKGROUND OF THE INVENTION

1. Field of the Invention

The present invention relates to method of inspecting an unevenness defect, which is known as “mura defect” (hereafter the unevenness defect is called as mura defect in the present application), in a pattern and an apparatus for inspecting the mura defect in a pattern, which detect a mura defect in a pattern formed on an image device or detect a mura defect in a pattern formed on a photomask that is used for fabricating an image device.

2. Description of the Related Art

Conventionally, an image device, such as an image pickup device, a display device, or a photomask for fabricating them have a mura defect inspection as one of their inspection items, which inspects the pattern formed on the surface. The mura defect is an error with having regularities that is different from the desired pattern being regularly arranged, and said different regularities have been unintentionally generated in said desired pattern by some causes through the fabrication process steps.

When a mura defect exists in an image pickup device or a display device, sensitivity fluctuation or display fluctuation might be generated, which ends up lowering the device performance. Further, in case of a mura defect being generated in a pattern of the photomask, which is used for fabricating an image pickup device or a display device, the mura defect might be transferred to the pattern of the image device, which is also likely to lower the performance of the image device.

The mura defect in a pattern of the image device or that of the photomask cannot be detected by the conventional pattern inspection method for inspecting the microscopic pattern because such a kind of the defects also looks like a pattern regularly arranged so far as a microscopic pattern inspection is applied. On the contrary, once an area is observed from a point of a whole pattern, the defect can be identified as the pattern different from the other part of the pattern. Therefore, the mura defect inspection comes to be mainly conducted by visual inspection such as oblique lighting inspection by human eyes.

However, since the visual inspection has a problem in that variations of the inspection results might be unavoidable among the inspecting operators. Therefore, a mura defect inspection apparatus is proposed such as disclosed in Japanese OPI patent publication JP Hei 10-300447. The mura defect inspection apparatus according to JP Hei 10-300447 irradiates the light onto a surface of the substrate on which a pattern is formed, where the scattered light from the edge part of the pattern is scanned by a CCD line sensor to detect the mura.

In the mura defect inspection apparatus described in JP Hei 10-300447, a fluorescent lamp or a halogen lamp may be employed for an irradiation light source disposed in an illuminating unit. In the mura defect inspection apparatus, the light irradiated from the illuminating unit is scattered at the edge part of unit pattern among the repeated patterns, where the irregularity of positions or the size of the repeated pattern are enhanced so that the mura defects can be visualized and detected.

However, since the illumination light source, such as a fluorescent lamp or a halogen lamp, irradiates the diffusion light without having specific orientation property, the reflected light that is scattered at the edge part of the unit pattern does not have any orientation property, and the influence of other reflected light, which is reflected from some part other than the edge part, might be also increased. Therefore, such a mura defect is eventually difficult to be located with accuracy by using the mura defect inspection apparatus conventional used.

### SUMMARY OF THE INVENTION

An object of the invention has been made in consideration of the above circumstances, and is to provide an inspection method and inspection apparatus of a mura defect, which can locate a mura defect clearly with highly accuracy.

A method of inspecting a mura defect in a pattern according to a first aspect is a method of inspecting a mura defect in a pattern including:
irradiating light onto a test object having a repeated patterns with a unit pattern being formed in regular arrangement on a surface;
receiving reflected light or transmitted light from the test object to convert it to received light data; and
analyzing the received light data to detect a mura defect generated in the repeated patterns,
wherein the light to be irradiated onto the test object is emitted from a light source which irradiates the light having an orientation property of the rays almost parallel.

A method of inspecting a mura defect in a pattern according to a second aspect is the method of inspecting a mura defect in a pattern according to the first aspect, wherein the light to be irradiated onto the test object is light having a parallelism within an angle of 2°.

A method of inspecting a mura defect in a pattern according to a third aspect is the method of inspecting a mura defect in a pattern according to the first and second aspects, including:
selecting and extracting light having a desired waveband from the light to be irradiated onto the test object or light reflected from the test object, and
using the selected and extracted light of the waveband for detecting a mura defect.

A method for inspecting a mura defect in a pattern according to a fourth aspect is the method of inspecting a mura defect in a pattern according to any one of the first to third aspects, wherein the test object is an image device or a photomask for fabricating said image device.

A method for inspecting a mura defect in a pattern according to a fifth aspect is an inspection apparatus of a mura defect in a pattern including:
an illuminating unit which irradiates light onto a test object having a repeated patterns with a unit pattern being formed in regular arrangement on a surface thereof; and
a photoreceptor which receives reflected light or transmitted light from the test object to convert it to received light data,
wherein the received light data is analyzed to detect a mura defect generated in the repeated pattern,
wherein the illuminating unit irradiates light onto the test object, which is emitted from a light source having a orientation property of the rays almost parallel.

A method for inspecting a mura defect in a pattern according to a sixth aspect is the inspection apparatus of a mura defect in a pattern according to the fifth aspect, wherein the illuminating unit irradiates light having a parallelism within an angle of 2° onto the test object.

A method for inspecting an the mura defect in a pattern according to a seventh aspect is the inspection apparatus of a mura defect in a pattern according to the fifth or sixth aspect, wherein the light source in the illuminating unit is an extra-high-voltage mercury lamp or xenon lamp.

A method for inspecting an the mura defect in a pattern according to an eighth aspect is the inspection apparatus of a mura defect in a pattern according to any one of the fifth to seventh aspects, including:
a selecting and extracting module which selects and extracts light of a desired waveband from the light to be irradiated onto the test object or light reflected from the test object,
wherein the selected and extracted light of the waveband is used to detect a mura defect.

A method for inspecting an the mura defect in a pattern according to a ninth aspect is the inspection apparatus of a mura defect in a pattern according to any one of the fifth to eighth aspects, wherein the test object is an image device or a photomask for fabricating this image device.

In the invention according the first to ninth aspects, the illuminating unit irradiates the light that is emitted from the light source and has the directional property near parallel rays onto the test object. Therefore, a directional property can be provided to the scattered light reflected and scattered at the edge part of the pattern of the test object, and consequently the influence of the reflected light from the parts other than the edge part in the scattered light is reduced to make the intensity of the scattered light clear. Thus, a mura defect can be made clearly identified, and the mura defect can be highly accurately detected.

In the invention according to the third or eighth aspects, the light of a desired waveband is selected and extracted from the light irradiated onto the test object or light led from the test object, and the selected and extracted light of the waveband is used to detect a mura defect. Therefore, the light of the waveband is selected and extracted depending on the types of the mura defects required for inspection, a mura defect to be a target can be made known sharply, and the mura defect can be highly accurately detected.

### BRIEF DESCRIPTION OF THE DRAWINGS

FIG. 1 is a perspective view illustrating the outline configuration of the first embodiment of the inspection apparatus of the mura defect in a pattern according to the invention;

FIG. 2 is a perspective view illustrating the illuminating unit shown in FIG. 1.

FIG. 3(A) shows the diagram illustrating the mura defect seen in stripes that is generated in the chip of the photomask shown in FIG. 1, and FIG. 3(B) and FIG. 3(C) are the diagrams illustrating the mura defect shown in FIG. 3(A) partially enlarged and a graph illustrating the analysis result.

FIGS. 4(A) to 4(D) show the mura defects generated in the repeated pattern formed on the chip of the photomask shown in FIG. 1; FIGS. 4(A) and 4(B) illustrate the mura defect in coordinate fluctuations, while FIGS. 4(C) and 4(D) illustrate the mura defect in dimension fluctuations.

FIG. 5 is a perspective view illustrating the second embodiment of the inspection apparatus of the mura defect in a pattern according to the invention.

### DESCRIPTION OF THE PREFERRED EMBODIMENTS

Embodiments of the present invention will be described hereinbelow by reference to the drawings. Unless otherwise specifically defined in the specification, terms have their ordinary meaning as would be understood by those of ordinary skill in the art.

Hereinafter, the best mode for carrying out the invention will be described based on the drawings.

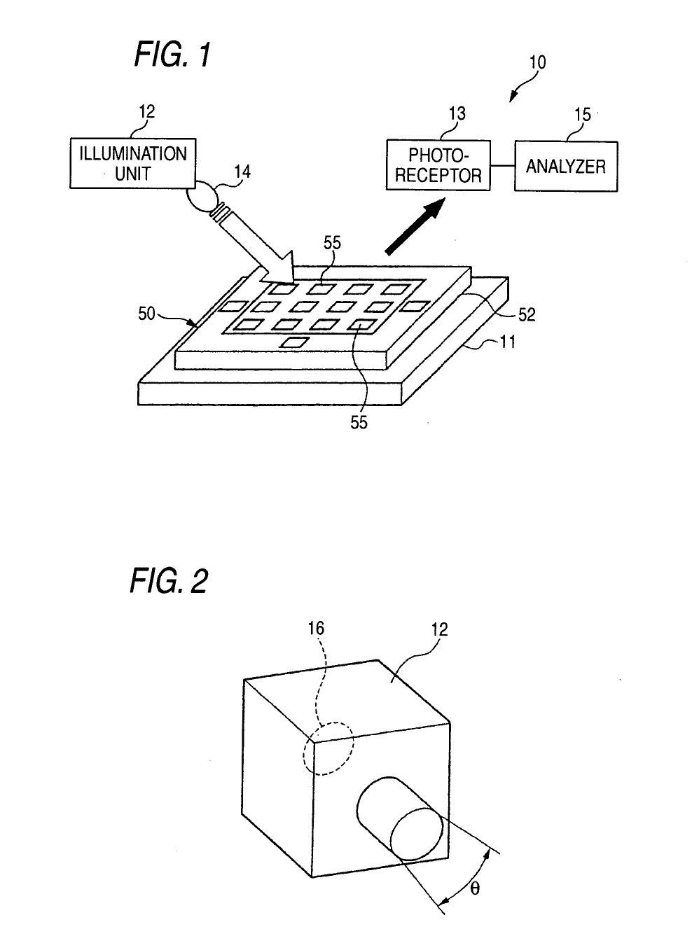

### [A] First Embodiment (FIG. 1 to FIG. 4)

FIG. 1 is a perspective view illustrating the outline configuration of a first embodiment of an inspection apparatus of a mura defect in a pattern according to the invention. FIG. 2 is a perspective view illustrating an illuminating unit shown in FIG. 1.

The mura defect inspection apparatus 10 shown in FIG. 1 is to detect a mura defect generated in repeated patterns 51 formed on the surface of a photomask 50 as a test object, which is configured to have a stage 11, an illuminating unit 12, a photoreceptor 13, an analyzer 15 and a wavelength filter (or a band-pass filter) 14 for selecting and extracting the desired light. In the embodiment, the photomask 50 is an exposure mask for fabricating the image devices, more specifically, a light receiving part of CCD.

Here, as for the image device in this invention, an image pickup device or a display device may be employed. AS for the image pickup device, a solid state image device such as CCD, CMOS, and VMIS are the typical ones, and for the display device, a liquid crystal display panel, a plasma display panel, an EL display panel, an LED display panel, and a DMD display panel might be considered. The photomask 50 is for fabricating any one of these image devices.

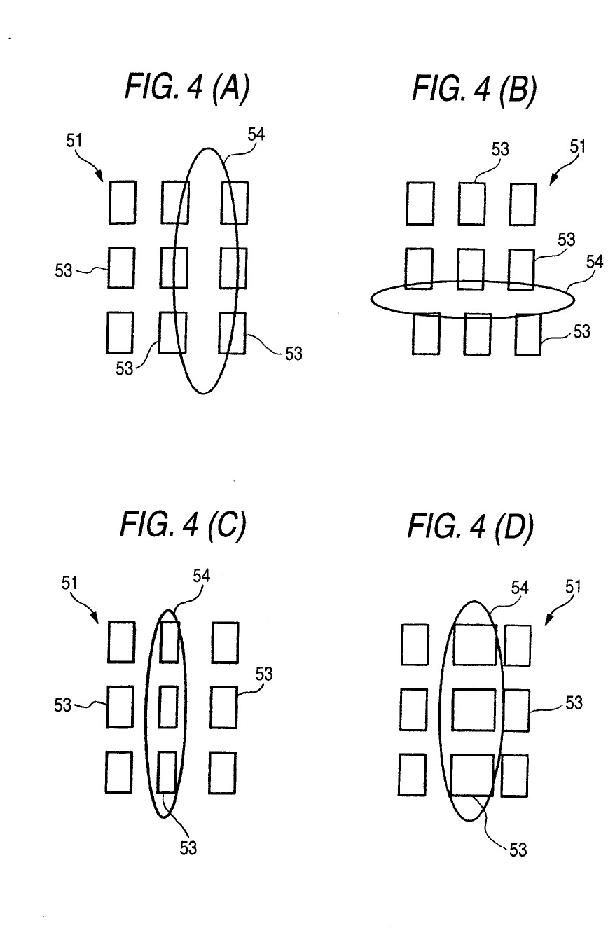

The photomask 50 is a mask having a shielding film such as a chrome film being formed on a transparent substrate 52 such as a glass substrate, where the shielding film is partially removed in desired repeated patterns 51 as shown in FIG. 4. The repeated patterns 51 are formed in a way such that a unit pattern 53 is regularly arranged. Anumerical reference 55 in FIG. 1 indicates a chip on which the repeated patterns 51 are formed, and a plurality of the chips might be formed on the photomask 50 in 5×5 pieces arrangement for example.

As for a fabrication method of the photomask 50, the shielding film is formed on the transparent substrate 52 at first, and a resist film is formed on the shielding film. Subsequently, an electron beam or laser beam irradiated from a beam writing unit is irradiated onto the resist film for writing the predetermined pattern to be exposed. Then, the written part or the non-written part are selectively removed to form a resist pattern. After that, the resist pattern is used as a mask to etch the shielding film, the repeated patterns 51 are thus formed by the shielding film, and finally the remaining resist is removed so that the photomask 50 can be fabricated.

In the fabrication process steps, scanning the electron beam or laser beam causes a seam during the pattern writing, which depends on the diameter or scan width of the beam being directly applied to the resist film. That is to say, a mura defect is generated by such errors caused during a pattern writing operation, which is sometimes periodically generated in the seam region at every writing operation.

In FIGS. 4(A) to 4(D), there shown the examples of the mura defects. In those Figures, the mura defect area is depicted by a circle 54. FIG. 4(A) shows a mura defect where misregistration is generated in a seam region written by the beam so as to vary a part of the intervals of the unit pattern 53 in a repeated patterns 51. FIG. 4(B) similarly shows a mura defect where the misregistration is generated in a seam region written by the beam so as to shift the positions of unit patterns 53 in a repeated patterns 51 with respect to the other unit patterns. The mura defects as shown in FIGS. 4(A) and 4(B) are called as the mura defect in coordinate fluctuations hereafter. Those shown in FIGS. 4(C) and 4(D) are the mura defect caused by fluctuation of the beam intensity of the writing unit so as to cause sizes of the unit pattern 53 of the repeated patterns 51 to be partially thinner or broader, and these mura defects are now called as the mura defect in dimensional fluctuations.

The stage 11 in the mura defect inspection apparatus 10 shown in FIG. 1 is a stage that places the photomask 50 thereon. The illuminating unit 12 is a unit that is disposed over one of the sides of the stage 11, from which the light is irradiated obliquely onto the repeated patterns 51 (FIG. 4) formed on each chip 55 being arranged on the surface of the photomask 50. As shown in FIG. 2, the light irradiated from the illuminating unit 12 onto the photomask 50 is emitted from an illumination light source 16 disposed in the illuminating unit 12, and has an orientation property of the rays almost parallel. More specifically, the light irradiated from the illuminating unit 12 is the light emitted from the illumination light source 16, but it is adjusted by a lens or slit to have the parallelism θ within an angle of 2°, preferably within an angle of 1°. Here, the parallelism is meant an angle of the light spread with respect to light traveling straight forward direction. In addition, the light irradiated from the illuminating unit 12 and the illumination light source 16 will be described later in detail.

As shown in FIG. 1, the photoreceptor 13 is a unit that is disposed over the other side of the stage 11, receiving the reflected light reflected from the repeated patterns 51 (see FIG. 4) of the chip 55 of the photomask 50, particularly the scattered light scattered from the edge part of the unit pattern 53 of the repeated patterns 51, where the received light is converted to the received light data. For example, a CCD line sensor or CCD area sensor might be employed as the photoreceptor 13. The received light data converted by the photoreceptor 13 is analyzed by the analyzer 15. More specifically, since the regularity of the received light data is fluctuated where a mura defect is generated in the repeated patterns 51 of the chip 55 of the photomask 50, the analyzer 15 analyzes the fluctuations in the regularity to detect a mura defect.

The wavelength filter (or band-pass filter) 14 is the filter that selects the light having a desired waveband from the light irradiated from the illuminating unit 12 to lead the selected and extracted light of the waveband to the repeated patterns 51 of the chip 55 of the photomask 50. There are multiple types of mura defects generated in the repeated patterns 51 of the chip 55 of the photomask 50 as already shown in FIG. 4, for example. In the mura defect inspection apparatus 10, the waveband of the light that can be high-sensitively detected is differed among the types of the mura defects. Therefore, the light of the waveband selected and extracted by the wavelength filter 14 is determined according to the types of mura defects required for inspection so as to be suitable for the high-sensitive detection required for the inspection.

For example, when the repeated patterns 51 has a mura defect in coordinate fluctuations shown in FIGS. 4(A) and 4(B), blue light ranging from 440 to 500 nm is used for the high-sensitive detection of the mura defect. Thus, the wavelength filter 14 selects and extracts the blue light from the light irradiated from the illuminating unit 12 so that the mura defect in coordinate fluctuations can be detected with highly accuracy. When the repeated patterns 51 have a mura defect in dimension fluctuations shown in FIGS. 4(C) and 4(D), green light ranging from 500 to 570 nm might be employed to detect the mura defect with high sensitivity. Therefore, the wavelength filter 14 selects and extracts green light from the light irradiated from the illuminating unit 12 so that the mura defect in dimension fluctuations can be detected with high accuracy. When a mura defect that can be detected more high-sensitively with red light ranging from 620 to 700 nm, the wavelength filter 14 selects and extracts red light from the light irradiate from the illuminating unit 12.

In addition, it is acceptable that the wavelength filter 14 is disposed before the position where the photoreceptor 13 receives the scattered light that has been reflected and scattered from the repeated pattern 51 of the chip 55 of the photomask 50 and one or multiple lights of a desired waveband is selected and extracted from the scattered light and lead to the photoreceptor 13. Besides on it, it is possible that the selecting and extracting module can be constituted by the band-pass filter including a color filter , other than the wavelength filter 14.

In the meantime, as described above, the illumination light source 16, which emits the light by the illuminating unit 12 adjusting the light to have the orientation property with substantial parallel rays, might be a light source emitting multiple color lights. In this regard, a light source that emits a coherent wavelength like a laser beam is not employed. Therefore, a fluorescent lamp, a halogen lamp, an extra-high-voltage mercury lamp, and a xenon lamp might be used for the light source. However, the fluorescent lamp and the halogen lamp have multiple points of emitting light, and thus they are quite difficult to produce parallel rays. However, the extra-high-voltage mercury lamp and the xenon lamp has a point source (accurately they are the two-points source), which readily produce parallel rays. In a viewpoint of readily producing the parallel rays, the illumination light source 16 of the embodiment might be preferably an extra-high-voltage mercury lamp or xenon lamp.

Furthermore the illuminating unit 12 adjusts the light emitted from the illumination light source 16 to the light having the orientation property of the rays almost parallel such that the parallelism θ is within an angle of 2°, and the irradiated light is irradiated onto the repeated patterns 51 of the chip 55 of the photomask 50. Therefore, the orientation property can be given to the scattered light that is reflected and scattered at the edge part of each unit pattern 53 (FIG. 4) of the repeated patterns 51. Further, the influence of the reflected light, being reflected from some parts other than the edge part, can be reduced in terms of said influence given to the scattered light so that the intensity of the scattered light can be enhanced, and a mura defect of the repeated patterns 51 comes to be clearly distinguishable and visualized.

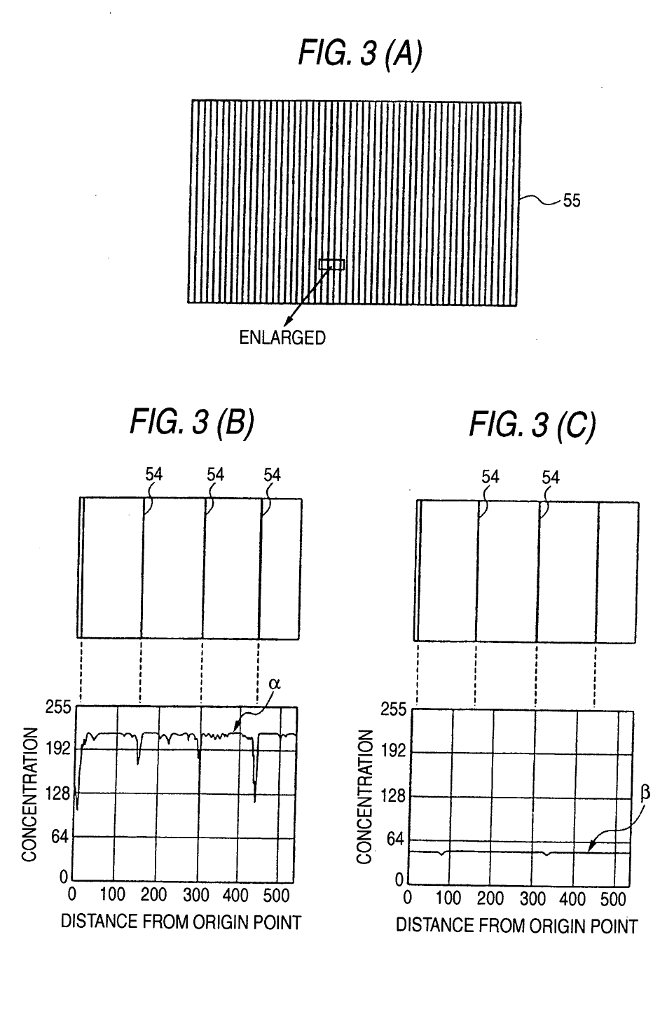

For example, in the case where a mura defect in dimension fluctuations as shown in FIG. 4(C) or 4(D) is generated in the repeated patterns 51, the mura defect turns to be such that the chip 55 of the photomask 50 is seen in stripes shown in FIG. 3(A) . Under such a circumstance, if the illumination light source 16 of the illuminating unit 12 is constituted by a halogen lamp of which irradiated light onto the repeated patterns 51 is adjusted to have the parallelism θ within an angle of 10°, the influence of the reflected light reflected from some parts other than the edge part might be increased in terms of said influence given to the scattered light scattered at the edge part of the unit patterns 53 of the repeated patterns 51, resulting in the intensity of the scattered light being made unclear and difficult to distinguish. In this regard, the received light data β by the photoreceptor 13 becomes flat as shown in FIG. 3(C), and a mura defect cannot be identified. This is because the light irradiated from the illuminating unit 12 using the halogen lamp emits the light whose rays have a wide range of parallelism such as ranging from the angles of 0° to 10°, the scattered light scattered at the edge part and the reflected light reflected from the other parts have various angles, as well as the individual lights are mixed together to make identification difficult.

On the other hand, concerning the same case of the mura defect such that the chip 55 of the photomask 50 is seen in stripes, but if the illumination light source 16 of the illuminating unit 12 is constituted by an extra-high-voltage mercury lamp, and the illuminating unit 12 irradiates the light onto the repeated patterns 51, which is adjusted to have the parallelism θ within an angle of 0.6°, and as the result, the influence of the reflected light reflected from some parts other than the edge part can be reduced in terms of the scattered light scattered at the edge part of the unit patterns 53 of the repeated patterns 51. In this regard, the intensity of the scattered light comes to be clearly distinguishable. Therefore, the received light data a by the photoreceptor 13 is observed to be suddenly changed at the position where the mura defect has been generated as shown in FIG. 3(B), and the mura defect can be identified. Thus, the analyzer 15 analyzes the received light data α so that the mura defect can be identified with high accuracy in its detection.

In addition, in the extra-high-voltage mercury lamp as the illumination light source 16 shown in FIG. 3(B), electrical energy is fed that has the same amount as that fed to the halogen lamp as the illumination light source 16 shown in FIG. 3(C). In the graphs shown in FIGS. 3(B) and 3(C), the horizontal length shows the distance from an origin point in the chip 55 of the photomask 50, and the vertical length shows the mura detection concentration of received light data.

Besides, as to the illuminating unit 12 irradiates the light, of which rays are almost parallel, onto the repeated patterns 51 of the chip 55 of the photomask 50, and thus light quantity distribution at the part where the light is irradiated (hereinafter, it is simply called ‘light quantity distribution’) can be suppressed small without reducing the irradiation energy of the light irradiated from the illuminating unit 12.

More specifically, the light source such as the fluorescent lamp and the halogen lamp irradiates diffusion light. In order to suppress the light quantity distribution low in the diffusion light, the irradiation energy irradiated from the illuminating unit needs to be reduced. However, when the irradiation energy is reduced, the sensitivity of the photoreceptor 13 to receive the scattered light scattered at the edge part of the unit pattern 51 is lowered, resulting in lowering the detection accuracy of mura defects. On the other hand, as described above, the illuminating unit 12 irradiates the light almost parallel rays onto the repeated patterns 51 to suppress the light quantity distribution as the high irradiation energy of the light irradiated from the illuminating unit 12 is held. Therefore, variations in intensity of the received light data can be suppressed by the photoreceptor 13 because the sensitivity of receiving the scattered light by the photoreceptor 13 is possible to be kept in good condition.

Next, a detection method of a mura defect generated in the repeated patterns. 51 of the chip 55 of the photomask 50 with the mura defect inspection apparatus 10 will be described below.

The illuminating unit 12 irradiates light onto the repeated patterns 51 of the chip 55 of the photomask 50, the photoreceptor 13 receives the light reflected from the repeated patterns 51 of the chip 55 to convert it to received light data, and the analyzer 15 analyzes the received light data to detect a mura defect generated in the repeated patterns 51. In this case, the illuminating unit 12 irradiates the light onto the repeated patterns 51, which is emitted from the illumination light source 16 having the orientation property of the rays almost parallel, where the parallelism θ is within an angle of 2°. In addition to this, the wavelength filter 14 selects and extracts the light which is suitable for detecting a mura defect with high accuracy according to the types of mura defects.

With the configuration above, the embodiments bring about the advantages as listed (1) and (2) below.

(1) The illuminating unit 12 irradiates the light onto the repeated pattern 51 of the chip 55 of the photomask 50 where said light is emitted from the illumination light source 16 and has the orientation property of the rays almost parallel, and thus the orientation property can be provided to the scattered light that is reflected and scattered at the edge part of the unit pattern 53 of the repeated pattern 51. Consequently, noise of the scattered light is reduced so as to distinct the intensity of the scattered light clear. Therefore, a mura defect generated in the repeated patterns 51 can be clearly distinct, and the mura-defect detection unit 10 can detect the mura defect with high accuracy.

(2) The wavelength filter 14 selects and extracts the light of a desired waveband from the light irradiated onto the repeated patterns 51 of the chip 55 of the photomask 50 from the illuminating unit 12, the photoreceptor 13 receives the selected and extracted light of the waveband and converts it to received light data, and the analyzer 15 analyzes the received light data to detect a mura defect. The wavelength filter 14 selects and extracts the light of the waveband depending on the types of mura defects required for inspection. Thus, the mura defect to be a target can be identified sharply, and the mura defect can be detected with further highly accuracy.

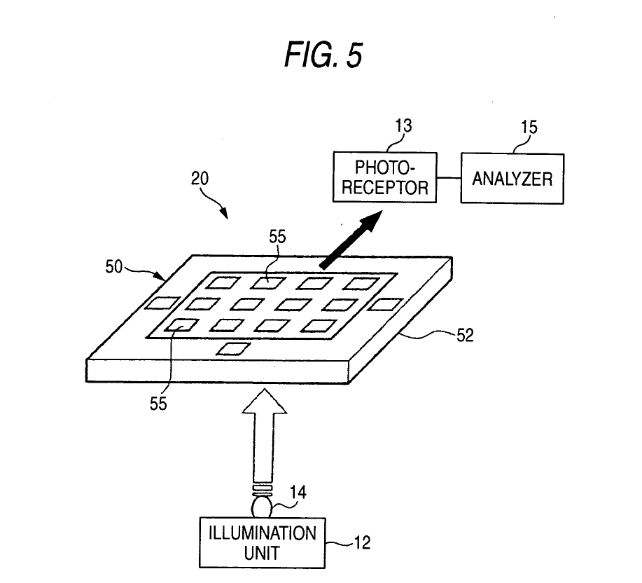

### [B] Second Embodiment (FIG. 5)

FIG. 5 is a perspective view illustrating a second embodiment of an inspection apparatus of a mura defect in a pattern according to the invention. In the second embodiment, the same parts as those of the first embodiment are designated the same signs for omitting the description.

In a mura defect inspection apparatus 20 of the second embodiment, an illuminating unit 12 is disposed under a photomask 50. Therefore, a photoreceptor 13 receives transmitted light that is irradiated from the illuminating unit 12 and transmits between repeated patterns 51 of a chip 55 of a photomask 50, particularly receives the diffracted light diffracted at the edge part of the unit pattern 53 in the transmitted light, and converts it to received light data.

Also in the second embodiment, the illuminating unit 12 irradiates the light that is emitted from an illumination light source 16 and has the orientation property of the rays almost parallel, for example, the parallelism θ within an angle of 2°, preferably within an angle of 1°, onto the repeated patterns 51 of the chip 55 of the photomask 50. Furthermore, also in the mura defect inspection apparatus 20, a wavelength filter 14 selects and extracts the light of a desired waveband from the light that is irradiated from the illuminating unit 12 and travels toward the chip 55 of the photomask 50, or from the light that transmits between the repeated patterns 51 of the chip 55 of the photomask 50. As the result, the filter selects and extracts the light of a waveband that can highly accurately detect a mura defect generated in the repeated patterns 51. Thus, the second embodiment also exerts the same advantages as the advantages (1) and (2) of the first embodiment.

The invention has been described based on the embodiments, but the invention is not limited to them.

For example, in the embodiments, it is described that the test object is the photomask 50, and the mura defect inspection apparatus 10 and apparatus 20 detect a mura defect generated in the repeated patterns 51 of the photomask 50 for fabricating the image device. However, there is no such a intention to exclude the situation such that the test object is the image device such as the image pickup device or the display device. In this case, it is acceptable that the mura defect inspection apparatus 10 and apparatus 20 detect a mura defect generated in a pixel pattern forming an image pickup array in the image pickup device (more specifically, the repeated pattern for fabricating the light receiving part of CCD and CMOS), and a mura defect generated in a pixel pattern forming a display panel in the display device (more specifically, the repeated patterns of a thin-film transistor, a counter substrate and a color filter of a liquid crystal display panel).

The present invention having been described with reference to the foregoing embodiments should not be limited to the disclosed embodiments and modifications, but may be implemented in many ways without departing from the spirit of the invention.

1. A method of inspecting a mura defect in a pattern comprising:
irradiating light onto a test object having a repeated patterns with a unit pattern being formed in regular arrangement on a surface thereof;
receiving reflected light or transmitted light from the test object to convert it to received light data; and
analyzing the received light data to detect a mura defect generated in the repeated patterns,
wherein the light to be irradiated onto the test object is emitted from a light source having a orientation property of the rays almost parallel.

2. The method of inspecting a mura defect in a pattern according to claim 1, wherein the light to be irradiated onto the test object is light having a parallelism within an angle of 2°.

3. The method of inspecting a mura defect in a pattern according to claim 1, comprising:
selecting and extracting light having a desired waveband from the light to be irradiated onto the test object or from a light reflected from the test object, and
using the selected and extracted light of the waveband for detecting a mura defect.

4. The method of inspecting a mura defect in a pattern according to any one of claims 1 to 3, wherein the test object is an image device or a photomask for fabricating said image device.

5. An inspection apparatus of a mura defect in a pattern comprising:
an illuminating unit which irradiates light onto a test object having a repeated patterns with a unit pattern being formed in regular arrangement on a surface thereof;
a photoreceptor which receives reflected light or transmitted light from the test object to convert it to received light data, and
a detector which analyzes received light data and detect a mura defect generated in the repeated patterns,
wherein the illuminating unit irradiates light onto the test object, said light being emitted from a light source having an orientation property of the rays almost parallel.

6. The inspection apparatus of a mura defect in a pattern according to claim 5, wherein the illuminating unit irradiates light having a parallelism within an angle of 2° onto the test object.

7. The inspection apparatus of a mura defect in a pattern according to claim 5 or 6, wherein the light source in the illuminating unit is an extra-high-voltage mercury lamp or xenon lamp.

8. The inspection apparatus of a mura defect in a pattern according to claim 5 or 6, comprising:
a selecting and extracting means for selecting and extracting light having a desired waveband from the light to be irradiated onto the test object or light led from the test object,
wherein the selected and extracted light of the waveband is used to detect a mura defect.

9. The inspection apparatus of a mura defect in a pattern according to claim 5 or claim 6, wherein the test object is an image device or a photomask for fabricating said image device.
